(19) United States
(12) Patent Application Publication
(10) Pub. No.: US 2009/0117303 A1
(43) Pub. Date: May 7, 2009

(54) ROLL COVER

(75) Inventor: Keigo Goshiki, Saitama (JP)

Correspondence Address: COLLEN IP, THE HOLYOKE MANHATTAN BUILDING, 80 SOUTH HIGHLAND AVENUE, OSSINING, NY, 10562, US

(73) Assignee: JUNKOSHA INC., Ibaraki 309-1603 (JP)

(21) Appl. No.: 11/577,786

(22) PCT Filed: Oct. 25, 2005
(86) PCT No.: PCT/JP05/19946

§ 371 Date: Apr. 23, 2007

(30) Foreign Application Priority Data
Oct. 29, 2004 (JP) 2004-316126

(51) Int. Cl. B32B 1/08

(52) U.S. Cl. 428/36.9; 977/715; 977/932

(57) ABSTRACT

A roll cover of the invention is a tubular roll cover made of a thermoplastic fluoropolymer for covering a round rod-like or cylindrical roll body, wherein the thermoplastic fluoropolymer contains from 0.5 to 5% by weight of a carbon nanotube. Since the thermoplastic fluoropolymer thus contains from 0.5 to 5% by weight of the carbon nanotube, the roll cover of the invention can secure necessary conductivity, in other words, have low chargeability of static electrification, secure good antistatic property and prevent an offset phenomenon by static electrification. Further, flexibility, mold releasability, surface cleanability and the like inherent in an ordinary fluoropolymer can be maintained well.

### TECHNICAL FIELD

The present invention relates to a roll cover which is used in a roll as, for example, a heat fixation roll or a pressure roll in copiers, printers or the like.

### BACKGROUND ART

A heat roll-type fixation device that conducts heat fixation of a toner is installed in copiers, printers or the like. In the fixation device, for example, a heat fixation roll or a pressure roll pressed by the heat fixation roll (hereinafter referred to as a “roll”) is mounted. Such a roll approximately comprises a round rod-like roll body and a tubular roll cover that covers its outer periphery, and the roll cover is bonded to the outer periphery of the roll body.

The outer periphery of the roll cover is required to have untackiness with a toner or a recording medium such as a paper. A fluoropolymer having properties such as heat resistance and untackiness is therefore appropriate as a material of the roll cover, and a tube made of a fluoropolymer is used as the roll cover. However, an ordinary fluoropolymer is low in conductivity. Therefore, when a roll cover made of the ordinary fluoropolymer is used in copiers, printers or the like, an offset phenomenon by static electrification that contaminates a subsequent image tends to occur. Accordingly, a fluoropolymer containing a conductive filler to provide conductivity (hereinafter referred to as a “conductive fluoropolymer”) is sometimes used. For example, a cylindrical member (roll) formed of a conductive fluoropolymer is disclosed in gazette of JP-A-2003-208033.

As a method for obtaining a conductive fluoropolymer, there is, for example, a method in which a conductive filler such as carbon black is incorporated into a fluoropolymer. However, for obtaining the conductivity appropriate for the roll cover, a large amount of carbon black has to be incorporated. Nevertheless, when a fluoropolymer containing a large amount of carbon black is used in a roll cover, the roll cover becomes hard, and the surface of the roll cover is coated with carbon black. Consequently, it causes mold releasability or surface cleanability inherent in an ordinary fluoropolymer to be impaired, so that the fluoropolymer is inappropriate as a roll cover. Further, in recent years, coloration or higher speed has been promoted in printers or copiers, the necessity for widening a nip width between a fixation roll and a pressure roll has been in demand, and flexibility of a roll has been required. When a roll cover is hard, it is impossible to secure sufficient flexibility of a roll, and a satisfactory nip width is hardly obtained.

The cylindrical member described in gazette of JP-A-2003-208033 comprises a conductive elastic layer formed on a support and a surface layer formed on the conductive elastic layer, the surface layer being a sleeve member (roll cover) which is previously molded with a conductive resin. Consequently, it is possible to provide the cylindrical member which can be produced relatively easily and has low hardness and high dimensional accuracy and whose volume resistivity value can be adjusted relatively easily. In the cylindrical member described in this gazette of JP-A-2003-208033, the conductivity is secured by the conductive elastic layer and the surface layer (sleeve member)(the volume resistivity value of the surface layer is greater than that of the conductive elastic layer). However, when the conductivity is secured by the sleeve member, a large amount of carbon black has to be incorporated. Thus, the sleeve member is more hardened, and the surface of the sleeve member is coated with carbon black. For this reason, flexibility of the cylindrical member cannot be secured, and mold releasability or surface cleanability of the surface layer is impaired.

In view of the foregoing various problems, the invention has been made, and an object of the invention is to provide a roll cover which effectively prevents occurrence of an offset phenomenon by static electrification while maintaining flexibility, mold releasability, surface cleanability and the like inherent in a fluoropolymer.

### DISCLOSURE OF THE INVENTION

For attaining the foregoing object, the roll cover of the invention is a tubular roll cover made of a thermoplastic fluoropolymer for covering a round rod-like or cylindrical roll body, wherein the thermoplastic fluoropolymer contains from 0.5 to 5% by weight of a carbon nanotube.

Thus, since the thermoplastic fluoropolymer contains from 0.5 to 5% by weight of the carbon nanotube, the roll cover of the invention can secure necessary conductivity, in other words, have low chargeability of static electrification, secure good antistatic property and prevent occurrence of an offset phenomenon by static electrification. Further, flexibility, mold releasability, surface cleanability and the like inherent in an ordinary fluoropolymer can be maintained well.

The roll cover of the invention is characterized in that the thermoplastic fluoropolymer is a tetrafluoroethylene/perfluoroalkylvinyl ether copolymer (PFA) containing a carbon nanotube. This makes it possible to further provide a roll cover excellent in untackiness and heat resistance.

### BRIEF DESCRIPTION OF THE DRAWINGS

FIG. 1 is a perspective view showing a part of a roll including a roll cover in the invention.

FIG. 2 is an electron micrograph of Example 5, evaluation 1. (1000 magnification)

FIG. 3 is an electron micrograph of Example 5, evaluation 2. (10,000 magnification)

FIG. 4 is an electron micrograph of Comparative Example 2, evaluation 1. (1000 magnification)

FIG. 5 is an electron micrograph of Comparative Example 2, evaluation 2. (10,000 magnification)

### BEST MODE FOR CARRYING OUT THE INVENTION

An embodiment of the roll cover in the invention is described below. Incidentally, the embodiment which is described below does not limit the invention in claims, and not all of combinations of characteristics described in the embodiment are essential to means for resolution of the invention.

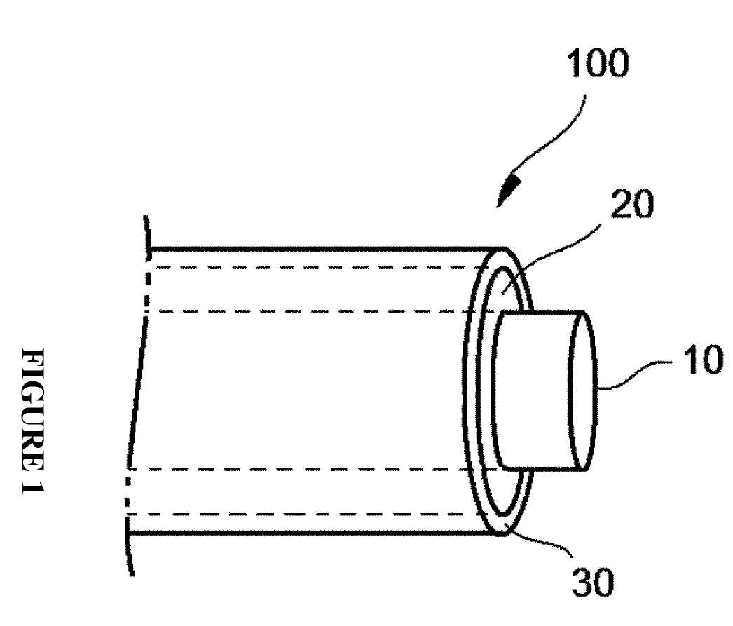

First, one embodiment of the invention is described by referring to FIG. 1. FIG. 1 is a perspective view showing a part of a roll 100 using a roll cover 30 in the invention.

The roll 100 which is schematically shown in FIG. 1 is a roll which is used in a heat fixation roll or a pressure roll pressed by the heat fixation roll in a recording device of copiers, printers or the like, and a roll cover 30 is put on a roll body 20.

A core 10 is, for example, a hollow or solid round rod made of a material such as a metal. It is preferably formed of aluminum, but any material will do so long as it is a core supporting the roll 100.

The roll body 20 is a cylindrical elastic body formed by being adhered to an outer periphery of the core 10. It is preferably made of a silicon resin. However, the roll body 20 is not limited to the elastic body, and it may be made of a metal or the like. In the embodiment shown in FIG. 1, the roll body 20 and the core 10 are provided respectively. However, a roll in which the core 10 is used as the roll body 20 is also available.

The roll cover 30 in the invention is, as shown in FIG. 1, a tube formed around the roll body 20 (in the case of the roll in which the core 10 is used as the roll body 20, the core 10 is the roll body 20), and is bonded to the outer periphery of the roll body 20. Consequently, the core 10, the roll body 20 and the roll cover 30 are linked to form the roll 100.

The roll 100 is used, as noted earlier, for example, as the heat fixation roll or the pressure roll pressed by the heat fixation roll in the recording device. The roll 100 (roll cover 30) is brought into contact with a recording medium such as paper, and a sheet. That is, while the outer periphery of the roll cover 30 is brought into contact with the recording medium, a heat fixation treatment of the recording device is conducted at a high temperature. For this reason, as a preferable material of the roll cover 30, various fluororesins (hereinafter referred to as “fluoropolymers”) having properties such as heat resistance and untackiness have been so far used. Meanwhile, an ordinary fluoropolymer is low in conductivity. When a roll cover made of an ordinary fluoropolymer is used in a recording device, the problem of the offset phenomenon by static electrification has occurred. Thus, a roll cover having conductivity has been in demand.

As the conductive fluoropolymer, there is a fluoropolymer containing a conductive filler such as carbon black. However, for providing desirable conductivity in the roll cover 30, a large amount of carbon black has to be incorporated. When the fluoropolymer containing a large amount of carbon black is used in the roll cover 30, the roll cover 30 is hardened to impair flexibility of the roll 100, and the surface of the roll cover 30 is coated with carbon black to impair mold releasability or surface cleanability important in the roll cover 30.

Under these circumstances, the inventor of the invention have found that a roll cover 30 made of a material obtained by mixing a thermoplastic fluoropolymer with from 0.5 to 5% of a carbon nanotube maintains flexibility and mold releasability of an ordinary fluoropolymer, and is low in chargeability of static electrification and excellent in antistatic property. This finding has led to the completion of the invention.

Examples of the thermoplastic fluoropolymer which can be used in the invention include a tetrafluoroethylene/perfluoroalkylvinyl ether copolymer (PFA), a tetrafluoroethylene/hexafluoropropylene copolymer (FEP), an ethylene/tetrafluoroethylene copolymer (ETFE), a polyvinylidene fluoride (PVDF) and the like. Of these, a tetrafluoroethylene/perfluoroalkylvinyl ether copolymer (PFA) or an ethylene/tetrafluoroethylene copolymer (ETFE) is preferable in view of durability. Further, in view of untackiness and heat resistance as well, a tetrafluoroethylene/perfluoroalkylvinyl ether copolymer (PFA) is most preferable.

With respect to the carbon nanotube which can be used in the invention, its synthetic method is not particularly limited. Examples thereof include a single-walled carbon nanotube (SWCNT) and a multi-walled carbon nanotube (MWCNT) which are synthesized by a vapor phase epitaxy method, an arc discharge method, a laser evaporation method or the like. The diameter (fiber diameter) of the carbon nanotube is not particularly limited. A carbon nanotube having a fiber diameter of from 1.5 to 200 nm is available. The length (fiber length) of the carbon nanotube is not particularly limited either. A carbon nanotube having an aspect ratio of 5 or more is advantageous for providing the characteristics of the invention.

A ratio (mixing ratio) at which the carbon nanotube is mixed into the thermoplastic fluoropolymer is preferably from 0.5 to 5% by weight. When the mixing ratio is not more than 0.5%, chargeability of static electrification and antistatic property are the same as those of an ordinary carbon nanotube-free fluoropolymer. When the mixing ratio is 5% or more, the thermoplastic fluoropolymer containing the carbon nanotube becomes hard, which involves a problem of flexibility of the roll.

A method in which the thermoplastic fluoropolymer is mixed with the carbon nanotube is not particularly limited. A method in which after mixing a powder or pellets of the thermoplastic fluoropolymer with the carbon nanotube, the mixture is kneaded with a single screw extruder or a twin-screw extruder, a method in which both components are kneaded with an intensive mixer or a Banbury mixer, or the like can be used. When the thermoplastic fluoropolymer is mixed with the carbon nanotube, a dispersant may be used. For example, dispersibility in the fluoropolymer can be increased by treating the carbon nanotube with a fluorine-based surfactant. Further, other additives and fillers maybe incorporated in combination unless impairing the characteristics of the invention.

When the material obtained by mixing the thermoplastic fluoropolymer with the carbon nanotube is molded into a tube to obtain the roll cover 30, an ordinary extrusion molding method is used. However, other methods are also available.

A diameter of the roll cover 30 can optionally be adjusted according to the size of the roll body 20. A thickness of the roll cover 30 can optionally be selected according to the use method of the roll 100. Generally, it is preferably from 10 to 300 μm, more preferably from 20 to 150 μm.

By the way, the roll cover 30 may be a type which is shrunk or not shrunk with heat radially or axially. For improving bondability with the roll body 20, the roll cover may be, or may not be subjected to inside treatment.

The roll 100 using the roll cover 30 is not particularly limited, and it can be utilized in various fields. It is most preferably utilized in a roll used in a heat or pressure fixation part of a recording device, a roll of a paper feeding portion or the like.

Examples and Comparative Examples of the invention are described below. First of all, materials in Examples 1 to 7 and Comparative Examples 1 to 3 described below were prepared.

### EXAMPLE 1

### Mixed Material Containing 0.5% of A Carbon Nanotube (Diameter 100 nm)

5 g of a carbon nanotube (VGCF-S (registered trademark), tuber diameter 100 nm, manufactured by Showa Denko K.K.) and 995 g of a granular fluoropolymer (Teflon (registered trademark) PFA 9738J, manufactured by Mitsui DuPont Fluorochemical K.K.) were thoroughly mixed in a stainless steel container. The mixture was melt-kneaded and extruded into strands with a twin-screw extruder (KZW 20-25G, manufactured by Technovel Corporation), and cooled in a water bath, and pellets having a diameter of 1.5 mm and a length of 2 mm were formed with a pelletizer. In the twin-screw extruder, a cylinder temperature was set at 350° C., a die temperature at 350° C., and a rotational number of a screw at 70 rpm.

### EXAMPLE 2

### Mixed Material Containing 1% of A Carbon Nanotube (Diameter 100 nm)

Pellets having a diameter of 1.5 mm and a length of 2 mm were formed by the same method and under the same conditions as in Example 1 using 10 g of the same carbon nanotube as in Example 1 and 990 g of the same granular fluoropolymer as in Example 1.

### EXAMPLE 3

### Mixed Material Containing 1.5% of A Carbon Nanotube (Diameter 100 nm)

Pellets having a diameter of 1.5 mm and a length of 2 mm were formed by the same method and under the same conditions as in Example 1 using 15 g of the same carbon nanotube as in Example 1 and 985 g of the same granular fluoropolymer as in Example 1.

### EXAMPLE 4

### Mixed Material Containing 2% of A Carbon Nanotube (Diameter 100 nm)

Pellets having a diameter of 1.5 mm and a length of 2 mm were formed by the same method and under the same conditions as in Example 1 using 20 g of the same carbon nanotube as in Example 1 and 980 g of the same granular fluoropolymer as in Example 1.

### EXAMPLE 5

### Mixed Material Containing 3% of A Carbon Nanotube (Diameter 100 nm)

Pellets having a diameter of 1.5 mm and a length of 2 mm were formed by the same method and under the same conditions as in Example 1 using 30 g of the same carbon nanotube as in Example 1 and 970 g of the same granular fluoropolymer as in Example 1.

### EXAMPLE 6

### Mixed Material Containing 1% of A Carbon Nanotube (Diameter 20 nm)

0.9 g of a carbon nanotube (CNT 20, tube diameter 20 nm, manufactured by K.K. Carbon NanoTec Research Institute) and 89.1 g of a pelletized fluoropolymer (Teflon (registered trademark) PFA 451HPJ, manufactured by Mitsui DuPont Fluorochemical K.K.) were charged into a 60 cc-mixer, Labo Plastmill (manufactured by K.K. Toyo Seiki Seisakusho), and mixed at 350° C. and 20 rpm for 20 minutes. The mixture was withdrawn, and formed into a sheet through a hot press, and pellets approximately 2 mm square were formed with a pelletizer. This procedure was repeated 10 times to obtain 900 g of a mixed material.

### EXAMPLE 7

### Mixed Material Containing 5% of A Carbon Nanotube (Diameter 150 nm)

50 g of a carbon nanotube (VGCF (registered trademark), tube diameter 150 nm, manufactured by Showa Denko K.K.) and 5% (2.5 g), based on the carbon nanotube, of potassium perfluorobutanesulfonate were mixed in methanol, and the mixture was dried at 110° C. Subsequently, the dried product was thoroughly mixed with 947.5 g of a granular fluoropolymer (Teflon (registered trademark) PFA 9738J, manufactured by Mitsui DuPont Fluorochemical K.K.) in a stainless steel container. The mixture was melt-kneaded and extruded into strands with a twin-screw extruder (KZW 20-25G, manufactured by Technovel Corporation), and cooled in a water bath, and pellets having a diameter of 1.5 mm and a length of 2 mm were formed with a pelletizer. By the way, in the twin-screw extruder, a cylinder temperature was set at 370° C., a die temperature at 370° C., and a rotational number of a screw at 50 rpm.

### COMPARATIVE EXAMPLE 1

### Carbon Nanotube-Free Thermoplastic Fluoropolymer

A natural fluoropolymer (Teflon (registered trademark) PFA 451 HPJ, manufactured by Mitsui DuPont Fluorochemical K.K.) was directly used as a material of a roll cover 30.

### COMPARATIVE EXAMPLE 2

### Mixed Material Containing 8.5% of Carbon Black

85 g of carbon black (Acetylene Black, manufactured by The Electro Chemical Industrial Co., Ltd.) and 915 g of a fluoropolymer powder (Teflon (registered trademark) PFA 350J, manufactured by Mitsui DuPont Fluorochemical K.K.) were thoroughly mixed in a stainless steel container. The mixture was melt-kneaded and extruded into strands with a twin-screw extruder (KZW 20-25G, manufactured by Technovel Corporation), and cooled in a water bath, and pellets having a diameter of 1.5 mm and a length of 2 mm were formed with a pelletizer. By the way, in the twin-screw extruder, a cylinder temperature was set at 365° C., a die temperature at 365° C., and a rotational number of a screw at 80 rpm.

### COMPARATIVE EXAMPLE 3

### Mixed Material Containing 7% of A Carbon Nanotube (Diameter 150 nm)

70 g of a carbon nanotube (VGCF (registered trademark), tube diameter 150 nm, manufactured by Showa Denko K.K.) and 930 g of a fluoropolymer powder (Teflon (registered trademark) PFA 345J, manufactured by Mitsui DuPont Fluorochemical K.K.) were thoroughly mixed in a stainless steel container. The mixture was melt-kneaded and extruded into strands with a twin-screw extruder (KZW 20-25G, manufactured by Technovel Corporation), and cooled in a water bath, and pellets having a diameter of 1.5 mm and a length of 2 mm were formed with a pelletizer. By the way, in the twin-screw extruder, a cylinder temperature was set at 370° C., a die temperature at 370° C., and a rotational number of a screw at 50 rpm.

### Production of A Roll Cover

The material obtained in each of Examples 1 to 7 and Comparative Examples 1 to 3 was molded into a roll cover (tube) having a diameter of 30 mm and a thickness of 50 μm with a single screw extruder having a cylinder diameter of 30 mm. The respective roll covers (hereinafter referred to as “sample tubes”) were subjected to the following evaluation tests 1 to 4.

### Evaluation Tests

### 1. Evaluation of Chargeability of Static Electrification (Evaluation 1)

A voltage of 15 kV or 30 kV was applied to a central portion of each sample tube having a length of 550 mm ten times at intervals of 1 second. Each voltage charged in the applied portion of each sample tube was measured after 15 seconds and 120 seconds. Incidentally, the voltage was applied to each sample tube using a tester (Electrostatic Discharge Tester Model ESD-300, manufactured by Sanki Denshi Kogyo K.K.). The charged voltage was measured with a measuring unit (static electrification potential measuring unit, STATIRON-DZ3, manufactured by Shishido Electrostatic, LTD.).

### 2. Evaluation of Chargeability of Static Electrification (Evaluation 2)

The sample tubes were cut to test pieces of 40×40 mm. An initial charged voltage and a time taken until a charged voltage was halved were measured according to JIS L1094, half-life measuring method (provided an applied voltage was not +10 kV but −10 kV). In a sample tube whose charged voltage was not halved even after 120 seconds, the charged voltage after 120 seconds was measured.

### 3. Evaluation of Flexibility (Evaluation 3)

The sample tubes were radially cut to rectangular pieces having a width of 5 mm and a length of 20 mm. Secant modulus at 5% strain was measured at 230° C. with an interchuck distance of 15 mm via a thermal analyzer TMA, and used as an index of flexibility.

### 4. Evaluation of Mold Releasability (Evaluation 4)

The sample tubes were enlarged with a scanning electron microscope, and the surface condition was observed to evaluate mold releasability.

### Test Results

The evaluation results of evaluation tests 1 to 3 are shown in Table 1.

TABLE 1
[Evaluation results]

| | Evaluation 1 | | | | | | |
|---|---|---|---|---|---|---|---|
| | Applied voltage 15 kV | | Applied voltage 30 kV | | Evaluation 2 | | |
| | Initial | Charged | Initial | Charged | Initial | Charged | |
| | charged | voltage after | charged | voltage after | charged | voltage after | Evaluation 3 |
| | voltage | 120 sec | voltage | 120 sec | voltage | 120 sec | Modulus |
| Material | (kV) | (kV) | (kV) | (kV) | [kV] | (kV) | (MPa) |
| Ex. 1 | 0.9 | 0.8 | 1.5 | 1.2 | −1.6 | −1.2 | 28 |
| Ex. 2 | 0.8 | 0.7 | 1.2 | 1 | −1.2 | −0.7 | 30 |
| Ex. 3 | 0.8 | 0.5 | 1 | 0.7 | −0.7 | −0.4 | 31 |
| Ex. 4 | 0.5 | 0.4 | 0.9 | 0.6 | −0.5 | *(92 sec) | 32 |
| Ex. 5 | 0 | 0 | 0.1 | 0 | 0 | 0 | 34 |
| Ex. 6 | 0.9 | 0.7 | 1.3 | 1.1 | −1.3 | −0.9 | 31 |
| Ex. 7 | 0 | 0 | 0 | 0 | 0 | 0 | 36 |
| CEx. 1 | 1.3 | 1.2 | 2.6 | 2.2 | −1.9 | −1.9 | 26 |
| CEx. 2 | 0.1 | 0 | 0.2 | 0 | 0 | 0 | 54 |
| CEx. 3 | 0 | 0 | 0 | 0 | 0 | 0 | 45 |

*(half-life sec)

As shown in Table 1, all of Examples 1 to 7 are, in comparison with Comparative Example 1 (carbon nanotube-free thermoplastic fluoropolymer), low in initial charged voltage and also low in charged voltage after 120 seconds, showing that static electrification is easily eliminated, and this is effective against an offset phenomenon by static electrification. Further, all of Examples 1 to 7 are, in comparison with Comparative Example 2 (8.5% carbon black-containing mixed material) and Comparative Example 3 (7% carbon nanotube (diameter 150 nm)-containing mixed material), low in modulus at 230° C., showing that flexibility is high at approximately a temperature of a fixation part in printers, copiers or the like.

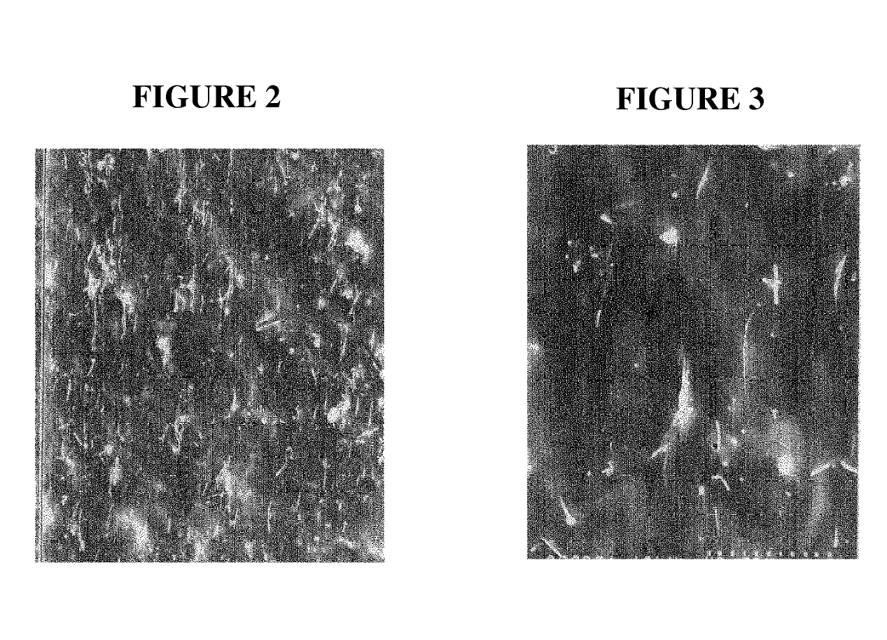

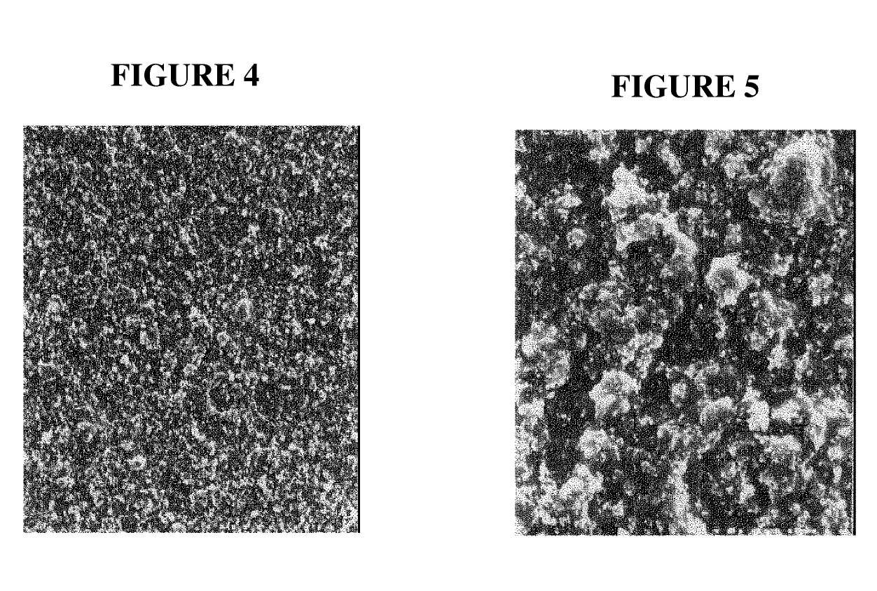

The surface condition of the sample tube is then described by referring to electron micrographs of Example 5 (3% carbon nanotube (diameter 100 nm)-containing mixed material) and Comparative Example 2 (8.5% carbon black-containing mixed material). From the results of evaluations 1 and 2 shown in Table 1, the sample tubes in Example 5 and Comparative Example 2 are found to have nearly the same chargeability of static electrification. Thus, the electron micrographs of the sample tube in Example 5 and the sample tube in Comparative Example 2 showing nearly the same chargeability of static electrification are shown in FIGS. 2 and 3 respectively.

The surface of the sample tube in Comparative Example 2 as shown in FIG. 3 is coated with carbon black to impair mold releasability of the fluoropolymer. Further, dust is incorporated into the convex-concave portion thereof, which might further decrease the printing quality. Meanwhile, the surface of the sample tube in Example 5 as shown in FIG. 2 is mostly occupied by the fluoropolymer to maintain mold releasability of the fluoropolymer. Moreover, since the surface is smooth without adhesion of dust, surface cleanability inherent in the fluoropolymer is also maintained well.

The embodiment and Examples of the invention have been thus far described. The roll cover 30 in the invention is the tubular roll cover 30 which is made of the thermoplastic fluoropolymer for covering the round rod-like or cylindrical roll body 20, the thermoplastic fluoropolymer containing from 0.5 to 5% by weight of the carbon nanotube. Since the thermoplastic fluoropolymer thus contains from 0.5 to 5% by weight of the carbon nanotube, the roll cover 30 in the invention can secure necessary conductivity, prevent occurrence of the offset phenomenon by static electrification, and further well maintain flexibility, mold releasability, surface cleanability and the like inherent in the ordinary fluoropolymer.

Moreover, the roll cover 30 in the invention is characterized in that the thermoplastic fluoropolymer is the carbon nanotube-containing tetrafluoroethylene/perfluoroalkylvinyl ether copolymer (PFA). The roll cover 30 which is further excellent in untackiness and heat resistance can thereby be provided.

By the way, the scope of the invention is not limited by the foregoing embodiment and Examples, and it can be applied to other various embodiments unless deviating from the description in claims. For example, since the roll cover 30 in the invention is excellent in electrical characteristics such as conductivity and static characteristics, it can widely be utilized in, for example, electronic and electric appliances requiring such characteristics.

### INDUSTRIAL APPLICABILITY

The roll cover in the invention can be used in a heat or pressure fixation part of copiers, printers or the like and be further applied to rolls used in various fields.

1. A roll cover which is a tubular roll cover made of a thermoplastic fluoropolymer for covering a round rod-like or cylindrical roll body, wherein the thermoplastic fluoropolymer contains from 0.5 to 5% by weight of a carbon nanotube.

2. The roll cover according to claim 1, wherein the thermoplastic fluoropolymer is a tetrafluoroethylene/perfluoroalkylvinyl ether copolymer (PFA).
